(19) United States
(12) Patent Application Publication
(10) Pub. No.: US 2010/0309111 A1
(43) Pub. Date: Dec. 9, 2010

(54) Electrophoretic Display Panel

(75) Inventors: Yi-Ching Wang, Hsinchu (TW); Ted-Hong Shinn, Hsinchu (TW); Tzu-Ming Wang, Hsinchu (TW); Kuang-Heng Liang, Hsinchu (TW)

Correspondence Address: LanWay IPR Services, P.O. Box 220746, Chantilly, VA, 20153, US

(73) Assignee: Prime View International Co., Ltd.

(21) Appl. No.: 12/632,801

(22) Filed: Dec. 8, 2009

(30) Foreign Application Priority Data
Jun. 5, 2009 (TW) 098118818

(51) Int. Cl. G09G 3/34

(52) U.S. Cl. 345/107

(57) ABSTRACT

An electrophoretic display panel includes a first substrate and an electrophoretic layer disposed on the first substrate. The first substrate includes a plurality of pixel areas. Each of the pixel areas has a first electrode and a second electrode formed therein. The first electrode is electrically insulated with the second electrode. The electrophoretic display panel has better light utility efficiency.

### CROSS-REFERENCE TO RELATED APPLICATIONS

This application is based upon and claims the benefit of priority from the prior Taiwanese Patent Application No. 098118818, filed Jun. 5, 2009, the entire contents of which are incorporated herein by reference.

### BACKGROUND

1. Field of the Invention

The present invention relates to a display device, and particularly to an electrophoretic display panel.

2. Description of the Related Art

FIG. 1 is a schematic, cross-sectional view of a conventional electrophoretic display panel. Referring to FIG. 1, the conventional electrophoretic display panel 100 includes an upper substrate 110, a lower substrate 120, an upper electrode 130, a lower electrode 140 and an electrophoretic layer 150. The upper substrate 110 faces the lower substrate 120. The upper electrode 130 is disposed on the lower surface of the upper substrate 110. The lower electrode 140 is disposed on the upper surface of the lower substrate 120. The electrophoretic layer 150 is disposed between the upper electrode 130 and the lower electrode 140. The electrophoretic layer 150 includes a plurality of microcapsules 151. Each of the microcapsules 151 includes a plurality of charged particles 152 and 154. A color of the charged particles 152 is different from a color of the charged particles 154, and charges of the charged particles 152 are opposite to charges of the charged particles 154.

A driving method of the conventional electrophoretic display panel 100 is to apply an voltage to the lower electrode 140, thereby forming an electric field between the upper electrode 130 and the lower electrode 140. As a result, the charged particles 152 and 154 are driven by the electric field to migrate toward different directions. When the charged particles 152 are above the charged particles 154, the color of the charged particles 152 is displayed. When the charged particles 154 are above the charged particles 152, the color of the charged particles 154 is displayed.

However, in the process of fabricating the conventional electrophoretic display panel 100, the steps of manufacturing the upper electrode 130 on the upper substrate 110 and manufacturing the lower electrode 140 on the lower substrate 120 make the process of fabricating the conventional electrophoretic display panel 100 become complicated. In addition, the upper substrate 110 and the lower substrate 120 of the conventional electrophoretic display 100 can be a plastic substrate. It is well kwon that manufacturing the electrode on the plastic substrate is very difficult. Therefore, manufacturing the upper electrode 130 on the upper substrate 110 and manufacturing the lower electrode 140 on the lower substrate 120 will increase the difficulty of the process of fabricating the conventional electrophoretic display panel 100. Moreover, the upper electrode 130 on the upper substrate 110 can reduce the light transmittance, thereby reducing the light utility efficiency of the conventional electrophoretic display panel 100.

Therefore, what is needed is an electrophoretic display panel to overcome the disadvantages of the conventional electrophoretic display panel.

### BRIEF SUMMARY

The present invention provides an electrophoretic display panel. The electrophoretic display panel has high light utility efficiency.

The present invention provides an electrophoretic display panel. The electrophoretic display panel includes a first substrate and an electrophoretic layer disposed on the first substrate. The first substrate includes a plurality of pixel areas. Each of the pixel areas has a first electrode and a second electrode formed therein. The first electrode is electrically insulated with the second electrode.

In one embodiment provided by the present invention, the first electrode and the second electrode in each of the pixel areas are formed on the upper surface of the first substrate.

In one embodiment provided by the present invention, the first electrode in each of the pixel areas has a plurality of bending portions. The second electrode is located in an area surrounded by the first electrode.

In one embodiment provided by the present invention, the first electrode in each of the pixel areas is a rectangular electrode or a U-shaped electrode.

In one embodiment provided by the present invention, the second electrode is formed on an upper surface of the first substrate. The electrophoretic display panel further includes an insulating layer formed on the first substrate to cover the second electrode. The first electrode is formed on the insulating layer.

In one embodiment provided by the present invention, the second electrode in each of the pixel areas is a sheet electrode. The first electrode is disposed on the second electrode.

In one embodiment provided by the present invention, the first electrode in each of the pixel areas includes a first strip-shaped electrode and a plurality of second strip-shaped electrodes. The second strip-shaped electrodes are connected to the first strip-shaped electrode. An extending direction of the second strip-shaped electrodes is different from an extending direction of the first strip-shaped electrode.

In one embodiment provided by the present invention, the first electrode in each of the pixel areas includes at least a closed electrode.

In one embodiment provided by the present invention, the first electrode in each of the pixel areas includes a plurality of the closed electrodes with different sizes. Geometrical centers of the closed electrodes are overlapped.

In one embodiment provided by the present invention, the second electrodes in the pixel areas are integrated into a sheet.

In one embodiment provided by the present invention, the first electrode in each of the pixel areas is a sheet electrode. The second electrode is disposed at a side of the first electrode.

In one embodiment provided by the present invention, the second electrode in each of the pixel areas includes at least a strip-shaped electrode or a closed electrode.

In one embodiment provided by the present invention, the electrophoretic layer includes a plurality of first charged particle.

In one embodiment provided by the present invention, the electrophoretic display panel further includes a reflective plate disposed on a lower surface of the first substrate. The first substrate is a transparent substrate and is located between the reflective plate and the electrophoretic layer.

In one embodiment provided by the present invention, the electrophoretic layer includes a plurality of first charged particles and a plurality of second charged particles. A color of the first charged particles is different from a color of the second charged particles. Charges of the first charged particles are opposite to charges of the second charged particles.

In one embodiment provided by the present invention, the electrophoretic display panel further includes a second substrate disposed on the electrophoretic layer.

In one embodiment provided by the present invention, the second substrate is a color filter substrate or a transparent substrate.

In one embodiment provided by the present invention, the electrophoretic display panel further includes a plurality of driving components electrically connected to the first electrodes of the pixel areas respectively.

In one embodiment provided by the present invention, the electrophoretic layer is selected from a group consisting of a microencapsulated electrophoretic layer, a microcup electrophoretic layer and a capillary electrophoretic layer.

The electrophoretic display panel of the present invention has the first electrode and the second electrode disposed on the first substrate. Decrease of the light transmittance due to the first electrode and the second electrode can be avoided effectively, thereby increasing the light utility efficiency of the electrophoretic display panel.

### BRIEF DESCRIPTION OF THE DRAWINGS

These and other features and advantages of the various embodiments disclose herein will be better understood with respect to the following description and drawings, in which like numbers refer to like parts throughout, and in which:

FIG. 1 is a schematic, cross-sectional view of a conventional electrophoretic display panel.

FIG. 2 is a schematic, cross-sectional view of an electrophoretic display panel in accordance with an embodiment of the present invention.

FIG. 3 is a schematic, cross-sectional view of the electrophoretic display panel shown in FIG. 2, which is in another displaying state.

FIG. 4 is a schematic view of a short pulse driving voltage applied to the electrophoretic display panel shown in FIG. 2.

FIG. 5 is a schematic, top view of the first electrode and the second electrode of the electrophoretic display panel shown in FIG. 2 in accordance with a first embodiment.

FIG. 6 is a schematic, top view of the first electrode and the second electrode of the electrophoretic display panel shown in FIG. 2 in accordance with a second embodiment.

FIG. 7 is a schematic, top view of the first electrode and the second electrode of the electrophoretic display panel shown in FIG. 2 in accordance with a third embodiment.

FIG. 8 is a schematic, cross-sectional view of an electrophoretic display panel in accordance with another embodiment of the present invention.

FIG. 9 is a schematic, cross-sectional view of the electrophoretic display panel shown in FIG. 8, which is in another displaying state.

FIG. 10 is a schematic, top view of the first electrode and the second electrode of the electrophoretic display panel shown in FIG. 8 in accordance with an embodiment.

FIG. 11 is a schematic, top view of the first electrode and the second electrode of the electrophoretic display panel shown in FIG. 8 in accordance with another embodiment.

FIG. 12 is a schematic, cross-sectional view of an electrophoretic display panel in accordance with further another embodiment of the present invention.

FIG. 13 is a schematic, cross-sectional view of the electrophoretic display panel shown in FIG. 12, which is in another displaying state.

FIG. 14 is a schematic, cross-sectional view of an electrophoretic display panel in accordance with still another embodiment of the present invention.

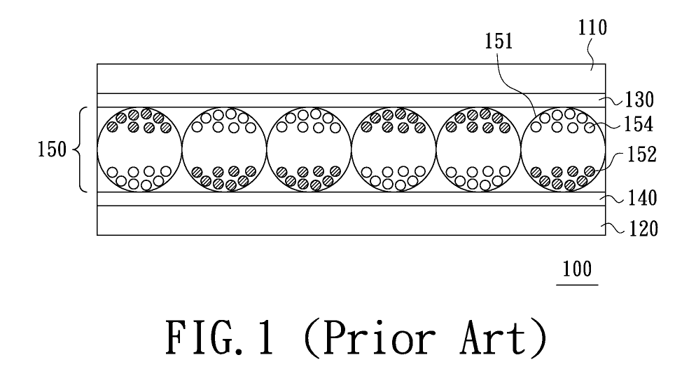

### DETAILED DESCRIPTION

An electrophoretic display panel includes a plurality of pixels. Because the structure of each of the pixels is identical, a pixel of the electrophoretic display panel is shown to denote the electrophoretic display panel in the following drawings.

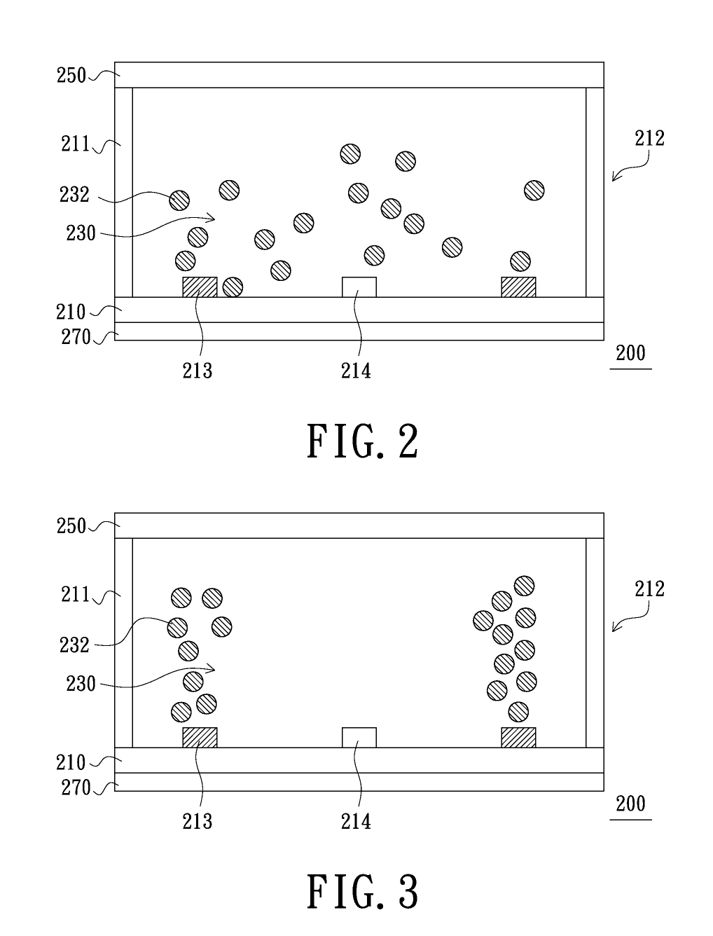

FIG. 2 is a schematic, cross-sectional view of an electrophoretic display panel in accordance with an embodiment of the present invention. Referring to FIG. 2, in the present embodiment, the electrophoretic display panel 200 includes a first substrate 210 and an electrophoretic layer 230 disposed on the first substrate 210. The first substrate 210 includes a plurality of pixel areas 212 (only one pixel area is shown in FIG. 2). A separating plate 211 can be disposed between two adjacent pixel areas 212. A first electrode 213 and a second electrode 214 are formed in each of the pixel areas 212. The first electrode 213 is electrically insulated with the second electrode 214.

In the electrophoretic display panel 200, the first electrode 213 and the second electrode 214 are both formed on an upper surface of the first substrate 210. The electrophoretic layer 230 includes a plurality of charged particles 232 (i.e., the first charged particles). In the present embodiment, the charged particles 232 are, for example, but not limited to, negatively charged black particles. The electrophoretic display panel 200 further includes a second substrate 250 disposed on the electrophoretic layer 230. The second substrate 250 can be a color filter substrate or a transparent substrate. The transparent substrate can be, for example, a glass substrate, a flexible substrate or a protective film. Additionally, when the first substrate 210 is, for example, a transparent substrate, a reflective plate 270 can be disposed on the lower surface of the first substrate 210. That is, the first substrate 210 is located between the reflective plate 270 and the electrophoretic layer 230. In the present embodiment, the reflective plate 270 is, for example, a white reflective plate.

Referring to FIGS. 2 to 4, a driving method of the electrophoretic display panel 200 will be described. It is noted that the driving method of the electrophoretic display panel 200 is not limited by the following description.

Referring to FIG. 2, the charged particles 232 are uniformly distributed in the electrophoretic layer 230. The pixel area 212 displays the color of the charged particle 232, for example, black.

Referring to FIG. 3, if it is expected that the pixel area 212 displays another color, a positive voltage is applied to the first electrode 213, thereby forming a transverse electric field between the first substrate 210 and the second substrate 250. Thus, the negatively charged particles 232 are driven by the transverse electric field to migrate towards the first electrode 213. As a result, a majority of incidence light are reflected by the reflective plate 270 so that the pixel area 212 displays another color. In detail, when a color filter substrate is not disposed on the pixel area 212, the pixel area 212 will display the color of the reflective plate 270, for example, white. When a color filter substrate is disposed on the pixel area 212, the pixel area 212 will display the color of the color photoresist of the color filter substrate.

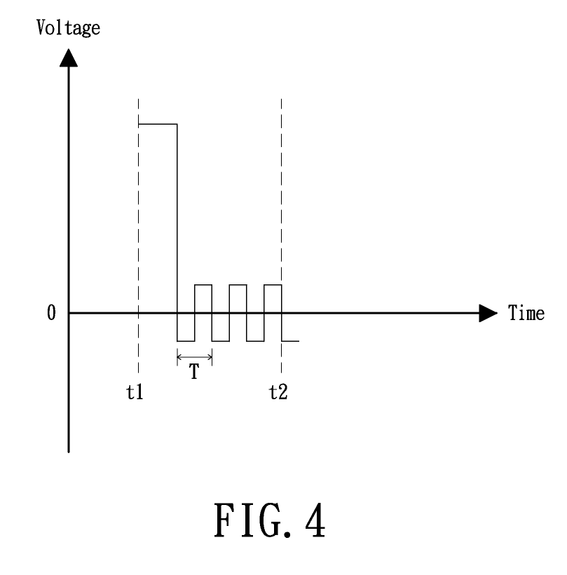

If it expected that the pixel area 212 displays black, a short pulse driving voltage shown in FIG. 4 is, for example, applied to the first electrode 213. The short pulse driving voltage can apply alternate positive and negative voltages to the first electrode 213, thereby making the charged particles 232 to be distributed uniformly in the electrophoretic layer 230 under the action of electric fields formed by the short pulse driving voltage. Thus, at the time t2, the pixel area 212 again displays the color of the charged particles 232, for example, black.

In the present embodiment, the first electrode 213 and the second electrode 214 are both disposed on the first substrate 20 of the electrophoretic display panel 200. Therefore, the exist of the first electrode 213 and the second electrode 214 can not reduce the light transmittance, thereby increasing the light utility efficiency of the electrophoretic display panel 200. Additionally, because the first electrode 213 and the second electrode 214 are both disposed one the first substrate 210, the electrophoretic display panel 200 in the present embodiment can form the first electrode 213 and the second electrode 214 simultaneously. Thus, it is not necessary to form electrodes on two substrates respectively, thereby simplifying the process of fabricating the electrophoretic display panel 200 and decreasing the difficulty of fabricating the electrophoretic display panel 200. Accordingly, the production efficiency of the electrophoretic display panel 200 in the present embodiment can be enhanced.

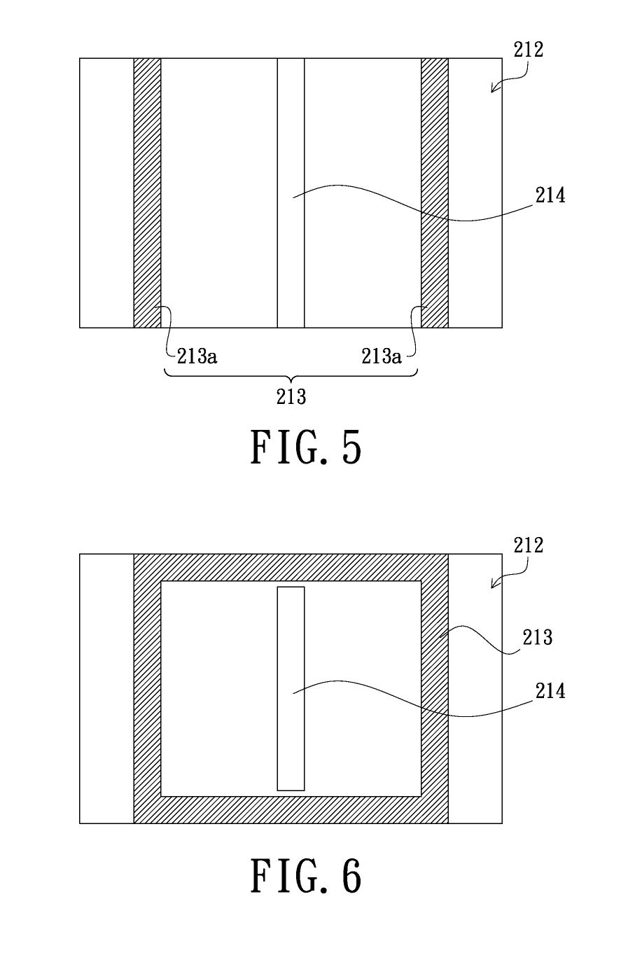

It is noted that the first electrode 213 and the second electrode 214 of the electrophoretic display panel 200 shown in FIG. 2 can have different configurations. Referring FIGS. 5 to 7, three embodiments of the first electrode 214 and the second electrode 214 are shown. But the configurations of the first electrode 213 and the second electrode 214 are not limited by the following description.

FIG. 5 is a schematic, top view of the first electrode and the second electrode of the electrophoretic display panel 200 shown in FIG. 2 in accordance with a first embodiment. Referring to FIG. 5, the first electrode 213 includes two strip-shaped electrodes 213a. The two strip-shaped electrodes 213a are, for example, parallel to each other and separated each other. The second electrode 214 is also a strip-shaped electrode and is located between the two strip-shaped electrodes 213a.

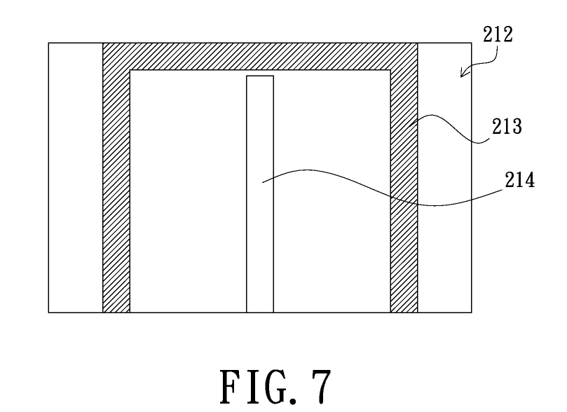

FIG. 6 is a schematic, top view of the first electrode and the second electrode of the electrophoretic display panel 200 shown in FIG. 2 in accordance with a second embodiment. FIG. 7 is a schematic, top view of the first electrode and the second electrode of the electrophoretic display panel 200 shown in FIG. 2 in accordance with a third embodiment. Referring to FIGS. 6 and 7, the first electrode 213 includes a plurality of bending portions. The second electrode 214 is a strip-shaped electrode. The second electrode 214 is located in an area surround by the first electrode 213. However, the first electrode 213 shown in FIG. 6 is different from the first electrode 213 shown in the FIG. 7. In FIG. 6, the bending first electrode 213 forms a close rectangular pattern and the second electrode 214 is surrounded by the close rectangular pattern formed by the first electrode 213. In FIG. 7, the bending first electrode 213 forms a U-shaped pattern and the second electrode 214 is located in an area surrounded by the U-shaped pattern formed by the first electrode 213.

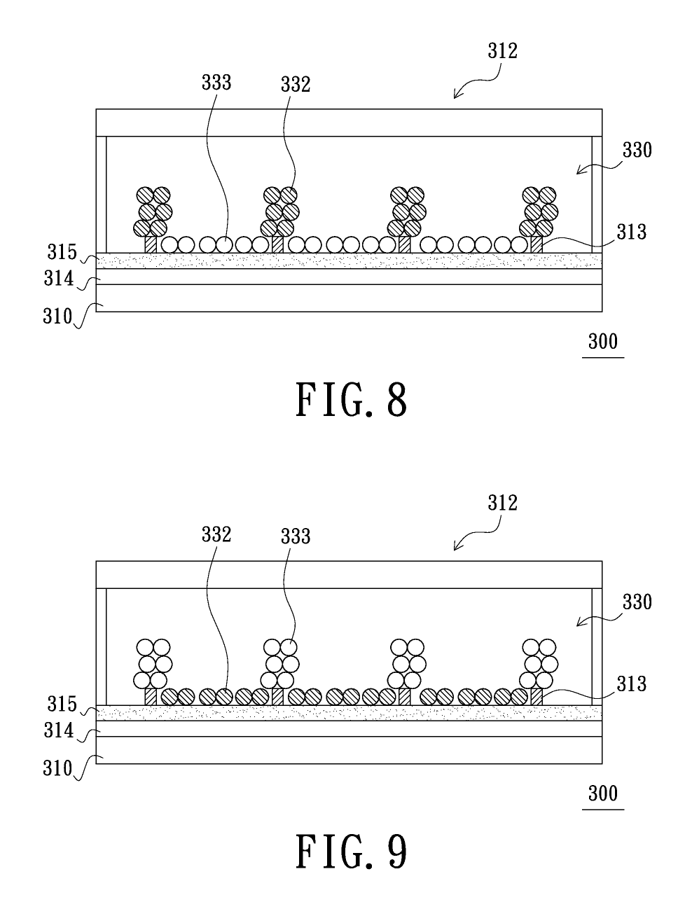

FIG. 8 is a schematic, cross-sectional view of the electrophoretic display panel in accordance with another embodiment of the present invention. Referring to FIG. 8, a plurality of first electrodes 313 and a second electrode 314 are formed in each pixel area 312 of the electrophoretic display panel 300. The second electrode 314 is disposed on the upper surface of a first substrate 310. An insulating layer 315 is disposed on the first substrate 310 to cover the second electrode 314. The first electrodes 313 are disposed on the insulating layer 315 and are located above the second electrode 314. The first electrodes 313 are arranged parallel to each other and separately. The second electrode 314 is, for example, a sheet electrode. The width of the second electrode 314 is more than the arrangement width of the first electrodes 313. The second electrode 314 can cover the whole pixel area 312. The second electrodes 314 in all pixel areas 312 of the electrophoretic display panel 300 can be integrated into a sheet. In another embodiment, the second electrodes 314 in all pixel areas 312 of the electrophoretic display panel 300 can be separated each other.

In the present embodiment, the electrophoretic layer 330 includes a plurality of first charged particles 332 and a plurality of second charged particles 333. A color of the first charged particles 332 is different from a color of the second charged particles 333, and charges of the first charged particles 332 are opposite to charges of the second charged particles 333. For example, the first charged particles 332 are negatively charged black particles, and the second charged particles 333 are positively charged white particles.

Referring to FIGS. 8 and 9, a driving method of the electrophoretic display panel 300 will be described. It is noted that the driving method of the electrophoretic display panel 300 is not limited by the following description.

Referring to FIG. 8, in a situation that the first charged particles 332 are negatively charged particles and the second charged particles 333 are positively charged particles. If it is expected that the pixel area 312 displays the color of the second charged particles 333, a positive voltage is applied to the first electrode 313. Thus, the first charged particles 332 and the second charged particles 333 are driven by an electric field to migrate towards the first electrode 313 and the second electrode 314 respectively. As a result, the second charged particles 333 above the second electrode 314 are distributed in a majority of area of the pixel area 312. The pixel area 312 will displays the color of the second charged particles 333, for example, white.

Referring to FIG. 9, if it is expected that the pixel area 312 displays the color of the first charged particles, a negative voltage is applied to the first electrode 313. Thus, the first charged particles 332 and the second charged particles 333 are driven by an electric field to migrate towards the second electrode 314 and the first electrode 313 respectively. As a result, the first charged particles 332 above the second electrode 314 are distributed in a majority of area of the pixel area 312. The pixel area 312 will displays the color of the first charged particles 332, for example, black.

In the present embodiment, the first electrodes 313 and the second electrode 314 are both disposed on the first substrate 310 of the electrophoretic display panel 300. Therefore, the exist of the first electrodes 313 and the second electrode 314 can not reduce the light transmittance, thereby increasing the light utility efficiency of the electrophoretic display panel 300.

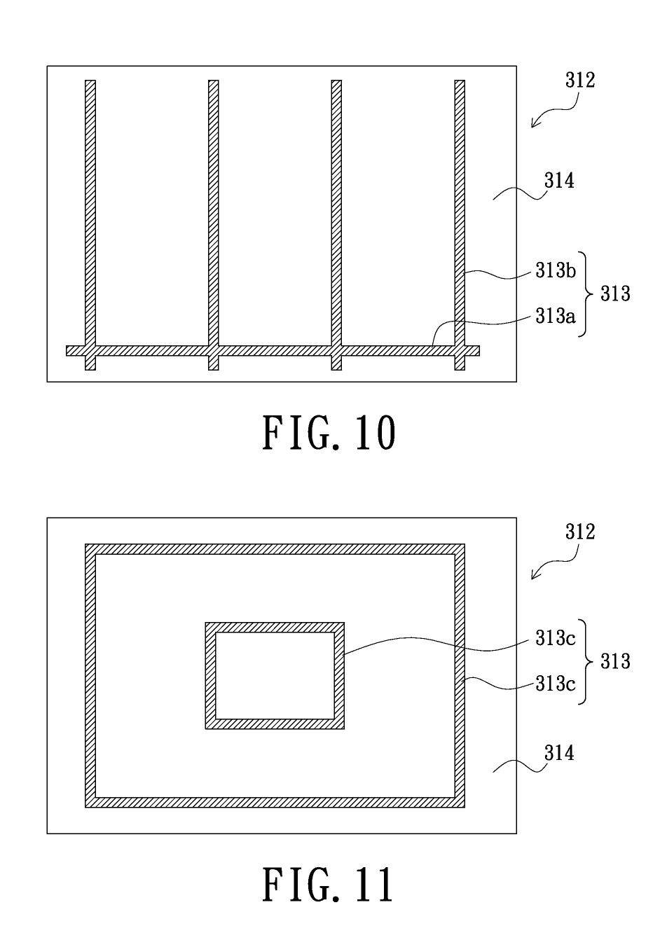

It is noted that the first electrodes 313 and the second electrode 314 of the electrophoretic display panel 300 shown in FIG. 8 can have different configurations. Referring FIGS. 10 and 11, two embodiments of the first electrodes 313 and the second electrode 314 are shown. But the configurations of the first electrodes 313 and the second electrode 314 are not limited by the following description.

FIG. 10 is a schematic, top view of the first electrode and the second electrode of the electrophoretic display panel 300 shown in FIG. 8 in accordance with an embodiment. Referring to FIG. 10, the first electrodes 313 includes a first strip-shaped electrode 312a and a plurality of second strip-shaped electrodes 313b. The second strip-shaped electrodes 313a are connected to the first strip-shaped electrode 312a. An extending direction of the second strip-shaped electrodes 313b is different from an extending direction of the first strip-shaped electrode 312a. In the present embodiment, the extending direction of the second strip-shaped electrodes 313b is, but not limited to, substantially perpendicular to the extending direction of the first strip-shaped electrode 312a.

FIG. 11 is a schematic, top view of the first electrode and the second electrode of the electrophoretic display panel 300 shown in FIG. 8 in accordance with another embodiment. Referring to FIG. 11, the first electrodes 313 in each pixel area 312 includes at least a closed electrode 313c. Each closed electrode 313c can form, for example, a close rectangular pattern. In the present embodiment, the first electrodes 313 in each pixel area 312 include two closed electrodes 313c with different sizes. Geometrical centers of the two closed electrodes 313c are overlapped. The two closed electrodes 313c can be connected each other by means of a connecting portion (not shown) so as to achieve electrically connection.

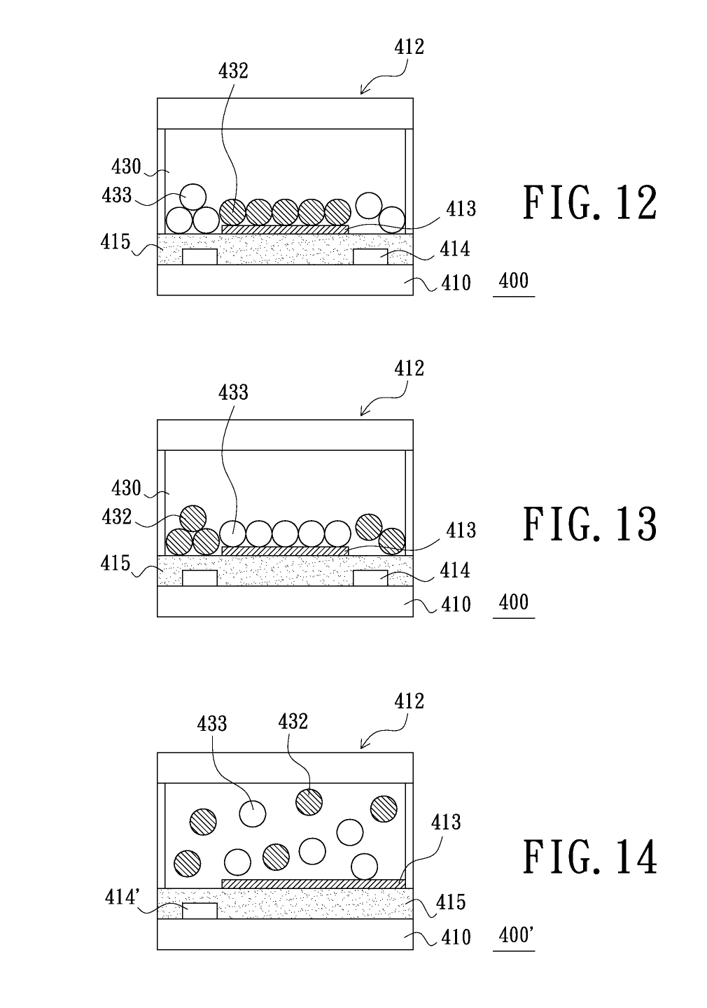

FIG. 12 is a schematic, cross-sectional view of the electrophoretic display panel in accordance with further another embodiment of the present invention. Referring to FIG. 12, a first electrode 413 and a second electrode 414 are formed in each pixel area 412 of the electrophoretic display panel 400. The second electrode 414 is disposed on the upper surface of a first substrate 410. An insulating layer 415 is disposed on the first substrate 410 to cover the second electrode 414. The first electrode 413 is formed on the insulating layer 415. The first electrode 413 is, for example, a sheet electrode. The second electrode 414 is disposed at a side of the first electrode 413. The first electrode 413 is located in an area surrounded by the second electrode 414. The configurations and the positions of the first electrode 413 and the second electrode 414 are similar to the configurations and the positions of the first electrode 213 and the second electrode 214 shown in FIGS. 5 to 7. In detail, the second electrode 414 can include two strip-shaped electrodes. The first electrode 413 is also a strip-shaped electrode and is located between the two strip-shaped electrodes. Otherwise, the second electrode 414 can be a close rectangular electrode and forms a close rectangular pattern and the first electrode 413 can be located in the close rectangular pattern formed by the second electrode 414. Otherwise, the second electrode 414 can be a U-shaped electrode and forms a U-shaped pattern and the first electrode 413 is located in the U-shaped pattern formed by the second electrode 414.

Referring to FIGS. 12 and 13, a driving method of the electrophoretic display panel 400 will be described. It is noted that the driving method of the electrophoretic display panel 400 is not limited by the following description.

Referring to FIG. 12, in a situation that the first charged particles 432 are negatively charged particles and the second charged particles 433 are positively charged particles. If it is expected that the pixel area 412 displays the color of the first charged particles 432, a positive voltage is applied to the first electrode 413. Thus, the first charged particles 432 and the second charged particles 433 are driven by an electric field to migrate towards the first electrode 413 and the second electrode 414 respectively. As a result, the first charged particles 432 above the first electrode 314 are distributed in a majority of area of the pixel area 412. The pixel area 412 will displays the color of the first charged particles 432, for example, black.

Referring to FIG. 13, if it is expected that the pixel area 412 displays the color of the second charged particles, a negative voltage is applied to the first electrode 413. Thus, the first charged particles 432 and the second charged particles 433 are driven by an electric field to migrate towards the second electrode 414 and the first electrode 413 respectively. As a result, the second charged particles 433 above the first electrode 413 are distributed in a majority of area of the pixel area 412. The pixel area 312 will displays the color of the second charged particles 433, for example, white.

In the present embodiment, the first electrodes 413 and the second electrode 414 are both disposed on the first substrate 410 of the electrophoretic display panel 400. Therefore, the exist of the first electrodes 413 and the second electrode 414 can not reduce the light transmittance, thereby increasing the light utility efficiency of the electrophoretic display panel 400.

FIG. 14 is a schematic, cross-sectional view of the electrophoretic display panel in accordance with still another embodiment of the present invention. Referring to FIG. 14, the electrophoretic display panel 400′ is similar to the electrophoretic display panel 400 shown in FIG. 13 except the second electrode. In the present embodiment, the second electrode 414′ includes a strip-shaped electrode and is disposed at a side of the first electrode 413. In the present embodiment, a driving method of the electrophoretic display panel 400′ is similar to the driving method of the electrophoretic display panel 400, as described above.

The electrophoretic display panels in the aforementioned embodiments of the present invention can be active electrophoretic display panels or passive electrophoretic display panels. If the electrophoretic display panels are active electrophoretic display panels, a driving component is disposed in each pixel area and is electrically connected to the first electrode. Additionally, the electrophoretic layer can be a microencapsulated electrophoretic layer, a microcup electrophoretic layer, a capillary electrophoretic layer or other electrophoretic layers.

The electrophoretic display panel of the present invention has the following advantageousness:

1. The first electrode and the second electrode are both disposed on the first substrate of the electrophoretic display panel. Therefore, decrease of the light transmittance due to the first electrode and the second electrode can be avoided effectively, thereby increasing the light utility efficiency of the electrophoretic display panel.

2. In one embodiment, because the first electrode and the second electrode are both disposed one the first substrate, the first electrode and the second electrode can be formed simultaneously. Thus, the process of fabricating the electrophoretic display panel can become simple and the difficulty of fabricating the electrophoretic display panel can be decreased. Thus, the production efficiency of the electrophoretic display panel can be enhanced.

The above description is given by way of example, and not limitation. ser Given the above disclosure, one skilled in the art could devise variations that are within the scope and spirit of the invention disclose herein, including configurations ways of the recessed portions and materials and/or designs of the attaching structures. Further, the various features of the embodiments disclose herein can be used alone, or in varying combinations with each other and are not intended to be limited to the specific combination described herein. Thus, the scope of the claims is not to be limited by the illustrated embodiments.

What is claimed is:

1. An electrophoretic display panel, comprising:
a first substrate comprising a plurality of pixel areas, each of the pixel areas having a first electrode and a second electrode formed therein, the first electrode being electrically insulated with the second electrode; and
an electrophoretic layer disposed on the first substrate.

2. The electrophoretic display panel as claimed in claim 1, wherein the first electrode and the second electrode in each of the pixel areas are formed on the upper surface of the first substrate.

3. The electrophoretic display panel as claimed in claim 2, wherein the first electrode in each of the pixel areas has a plurality of bending portions, and the second electrode is located in an area surrounded by the first electrode.

4. The electrophoretic display panel as claimed in claim 3, wherein the first electrode in each of the pixel areas is a rectangular electrode or a U-shaped electrode.

5. The electrophoretic display panel as claimed in claim 1, further comprising an insulating layer formed on the first substrate to cover the second electrode, the second electrode being formed on an upper surface of the first substrate, and the first electrode being formed on the insulating layer.

6. The electrophoretic display panel as claimed in claim 5, wherein the second electrode in each of the pixel areas is a sheet electrode, and the first electrode is disposed on the second electrode.

7. The electrophoretic display panel as claimed in claim 6, wherein the first electrode in each of the pixel areas comprises a first strip-shaped electrode and a plurality of second strip-shaped electrodes, the second strip-shaped electrodes are connected to the first strip-shaped electrode, an extending direction of the second strip-shaped electrodes is different from an extending direction of the first strip-shaped electrode.

8. The electrophoretic display panel as claimed in claim 6, wherein the first electrode in each of the pixel areas comprises at least a closed electrode.

9. The electrophoretic display panel as claimed in claim 8, wherein the first electrode in each of the pixel areas comprises a plurality of the closed electrodes with different sizes, and geometrical centers of the closed electrodes are overlapped.

10. The electrophoretic display panel as claimed in claim 6, wherein the second electrodes in the pixel areas are integrated into a sheet.

11. The electrophoretic display panel as claimed in claim 5, wherein the first electrode in each of the pixel areas is a sheet electrode, and the second electrode is disposed at a side of the first electrode.

12. The electrophoretic display panel as claimed in claim 11, wherein the second electrode in each of the pixel areas comprises at least a strip-shaped electrode or a closed electrode.

13. The electrophoretic display panel as claimed in claim 1, wherein the electrophoretic layer comprises a plurality of first charged particles.

14. The electrophoretic display panel as claimed in claim 13, further comprising a reflective plate disposed on a lower surface of the first substrate, and the first substrate being a transparent substrate and being located between the reflective plate and the electrophoretic layer.

15. The electrophoretic display panel as claimed in claim 1, wherein the electrophoretic layer comprises a plurality of first charged particles and a plurality of second charged particles, a color of the first charged particles is different from a color of the second charged particles, and charges of the first charged particles are opposite to charges of the second charged particles.

16. The electrophoretic display panel as claimed in claim 1, further comprising a second substrate disposed on the electrophoretic layer.

17. The electrophoretic display panel as claimed in claim 16, wherein the second substrate is a color filter substrate or a transparent substrate.

18. The electrophoretic display panel as claimed in claim 1, further comprising a plurality of driving components electrically connected to the first electrodes of the pixel areas respectively.

19. The electrophoretic display panel as claimed in claim 1, wherein the electrophoretic layer is selected from a group consisting of a microencapsulated electrophoretic layer, a microcup electrophoretic layer and a capillary electrophoretic layer.
